(19) United States
(12) Patent Application Publication
(10) Pub. No.: US 2004/0264701 A1
(43) Pub. Date: Dec. 30, 2004

(54) Method for transmitting/receiving encoded ultra-wideband signal and terminal therefor

(76) Inventors: Jong-Hwa Lee, Suwon-shi (KR); Sang-Il Lee, Seoul (KR); Yun-Kyung Oh, Seoul (KR); Jong-Hun Lee, Suwon-shi (KR); Seo-Won Kwon, Suwon-shi (KR)

Correspondence Address: CHA & REITER, LLC, 210 ROUTE 4 EAST STE 103, PARAMUS, NJ, 07652, US

(21) Appl. No.: 10/721,014

(22) Filed: Nov. 21, 2003

(30) Foreign Application Priority Data
Jun. 24, 2003 (KR) 2003-41151

(51) Int. Cl. H04K 1/00

(52) U.S. Cl. 380/270

(57) ABSTRACT

Encoded data are transmitted with ultra-wideband (UWB) signals and a corresponding security key is transmitted through an infrared (IR) channel, to provide a secure method for transmitting a relatively large amount of data. The received security key is used by the receiver to decode the received data.

### CLAIM OF PRIORITY

This application claims priority to an application entitled “Method for transmitting/receiving encoded ultra-wideband signal and terminal therefore,” filed in the Korean Intellectual Property Office on Jun. 24, 2003 and assigned Serial No. 2003-41151, the contents of which are hereby incorporated by reference.

### BACKGROUND OF THE INVENTION

1. Field of the Invention

The present invention relates to an ultra-wideband (hereinafter, referred to as “UWB”) terminal, and more particularly to a UWB terminal for transmitting/receiving a security key through an infrared radiation (hereinafter, referred to as “IR”) channel and encoding/decoding transmission data using the security key.

2. Description of the Related Art

UWB technology is a wireless communication method that uses pulses having a very short time width (for example, 1 ns or less), not using a carrier (a cosine wave for modulating information). The spectrum occupies a bandwidth greater than 20 percent of the center frequency or a bandwidth of at least 500 MHz. Uniquely, UWB is capable of supporting a wireless transmission speed of 100 Mbps or more with millimeter waves (MMW). UWB, also called “impulse radio”, “time-domain”, “carrier free,” is a technology different from radio frequency (RF) technology, which is a wireless communication method using a carrier of a specific frequency and performing a communication within a several MHz bandwidth centered at the specific frequency. Among the characteristics of UWB, which uses an ultra wideband bandwidth of several GHz, are robustness to multipath fading, and the capability for distance measurement, as with a spread-spectrum communication method. Accordingly, wireless communication methods using the UWB have attracted attention.

Disadvantageously, however, serious security vulnerability in technique and in the environment exists for wireless communication methods using the UWB, as with in conventional wireless communication technologies. Due to the large amount of data transmitted by UWB, security concerns heighten since the leakage of relatively more information to a third person is at stake.

Infrared radiation (IR) as a wireless medium is known for having excellent security although it can, in a practical sense, accommodate only a relatively small amount information. It is therefore used in transmitting security information (for example, an authorization password, credit information, and so forth). For example, a financial payment system typically transmits a small amount by means of the IR, not a large amount by the RF or the UWB, in order to send documents which must be maintained in security, such as an authorization password, personal credit information, or etc.

Although conventional wireless communications methods are known for encoding the wireless signal data itself, if a third person know the encoding technology the encoded data can be easily restored by the third person.

Since transmission data cannot be sufficiently secured in conventional wireless communication due to technical and environmental reasons, conventional communication resorts to either transmitting a large amount of data that suffers from leakage of information to some degrees or to transmitting a small amount of data by means of IR. None of the methods currently in use is capable of transmitting a large amount of data while maintaining security.

### SUMMARY OF THE INVENTION

The present invention has been made to solve the above-mentioned problems occurring in the prior art, and, in one aspect, provides a device and a method capable of transmitting a large amount of data while maintaining security.

A second aspect of the present invention provides a device and a method for transmitting data encoded by a security key with UWB signals and for transmitting the security key via an IR channel.

The above aspects are realized in a method for transmitting an encoded ultra-wideband signal in which, as a first step, an ultra-wideband terminal of a transmission part requests a security key to an ultra-wideband terminal of a reception part using an infrared radiation channel. In a second step, the ultra-wideband terminal of the transmission part receives, in response to the request, a security key transmitted from the ultra-wideband terminal of the reception part. Thirdly, the ultra-wideband terminal of the transmission part encodes transmission data using the received security key. The ultra-wideband terminal of the transmission part then embodies the encoded transmission data within the encoded ultra-wideband signal that it transmits to the ultra-wideband terminal of the reception part.

In another aspect of the present invention, a method for receiving an encoded ultra-wideband signal includes a first step of generating a security key in response to a security key request signal received from an ultra-wideband terminal of a transmission part. As a second step, the security key is transmitted to the ultra-wideband terminal of the transmission part using an infrared radiation channel and is stored. In a third step, reception is made of encoded data transmitted from the ultra-wideband terminal of the transmission part through UWB. A fourth step uses the security key stored in the second step to restore original data from the data received through the third step.

### BRIEF DESCRIPTION OF THE DRAWINGS

The above and other aspects, features and advantages of the present invention will be more apparent from the following detailed description taken in conjunction with the accompanying drawings, in which:

FIG. 1 is a conceptual view illustrating a process of encoding and transmitting an ultra-wideband signal in accordance with the present invention;

FIG. 2 is a conceptual view illustrating a process of receiving and restoring an ultra-wideband signal in accordance with the present invention;

FIGS. 3 and 4 are conceptual views illustrating communication status among ultra-wideband terminals according to an embodiment of the present invention;

FIG. 5 is a view illustrating a process of encoding/decoding an ultra-wideband signal according to an embodiment of the present invention;

FIG. 6 is a flowchart for explaining a process of encoding and transmitting an ultra-wideband signal according to an embodiment of the present invention;

FIG. 7 is a flowchart for explaining a process of decoding a received ultra-wideband signal according to an embodiment of the present invention;

FIG. 8 is a functional block diagram of an ultra-wideband terminal according to an embodiment of the present invention; and

FIG. 9 is a block diagram for describing processes of encoding and transmitting an ultra-wideband signal and also receiving and decoding an encoded ultra-wideband signal, between ultra-wideband terminals according to an embodiment of the present invention.

### DETAILED DESCRIPTION OF THE PREFERRED EMBODIMENT

A method for transmitting/receiving an encoded ultra-wideband signal and a terminal therefor according to preferred embodiments of the present invention will be described with reference to the accompanying drawings. In the following description of the present invention, detailed description of known functions and configurations incorporated herein will be omitted for clarity of presentation.

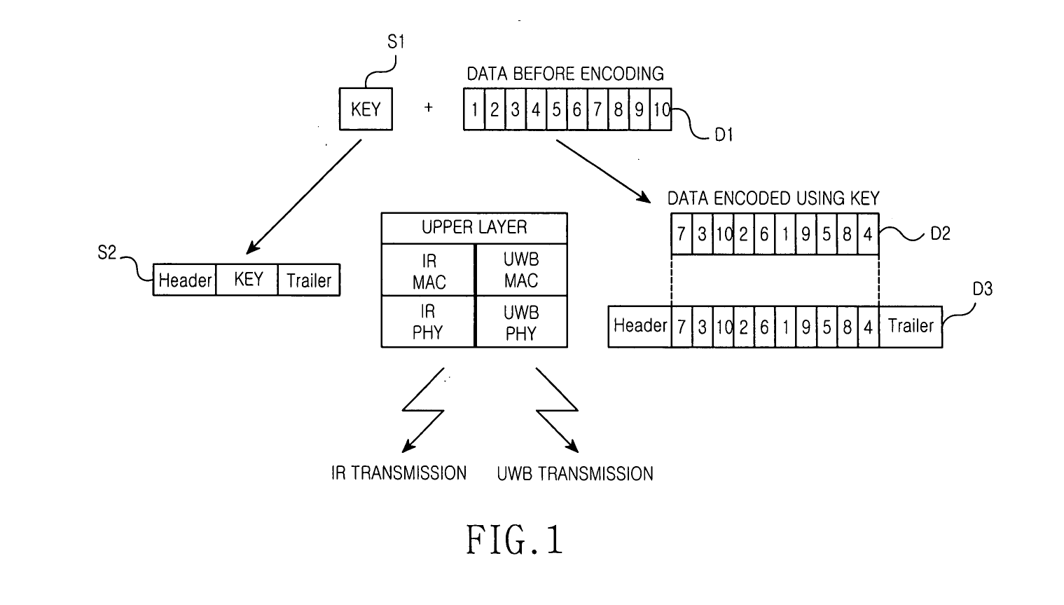

FIG. 1 is a conceptual view illustrating a process of encoding and transmitting an ultra-wideband signal according to the present invention. Original data D1 are encoded using a security key S1, and encoded data D2 are changed into a format to transmit, i.e., into ultra-wideband (UWB) data D3, using UWB. The security key S1, which encodes the original data D1, is changed into a format to transmit using infrared radiation (IR), that is into IR data S2. Next, the UWB data D3 are transmitted using UWB, and the IR data S2 are transmitted using an IR channel.

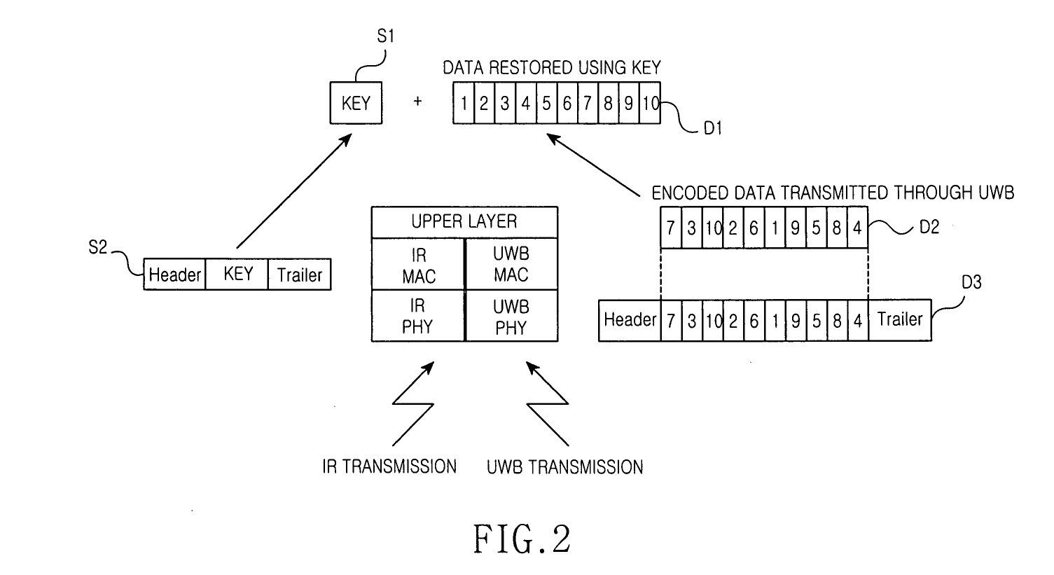

FIG. 2 is a conceptual view illustrating a process of receiving and restoring an ultra-wideband signal in accordance with the present invention. Specifically, the UWB data D3 is received and restored, using the IR data S2 that has been transmitted. Referring to FIG. 2, a UWB terminal receives the UWB data D3 using UWB, and receives the IR data S2 using an IR channel. Subsequently, the UWB terminal extracts encoded data D2 and a security key SI from the UWB data D3 and the IR data S2, and then uses the security key S1 to restore original data D1, i.e., the data before encoding, from the encoded data D2.

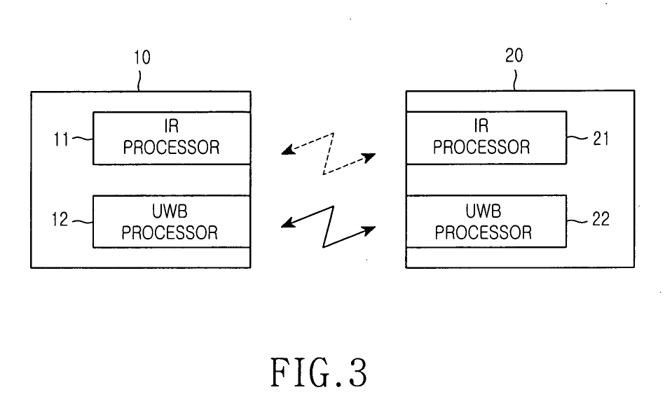

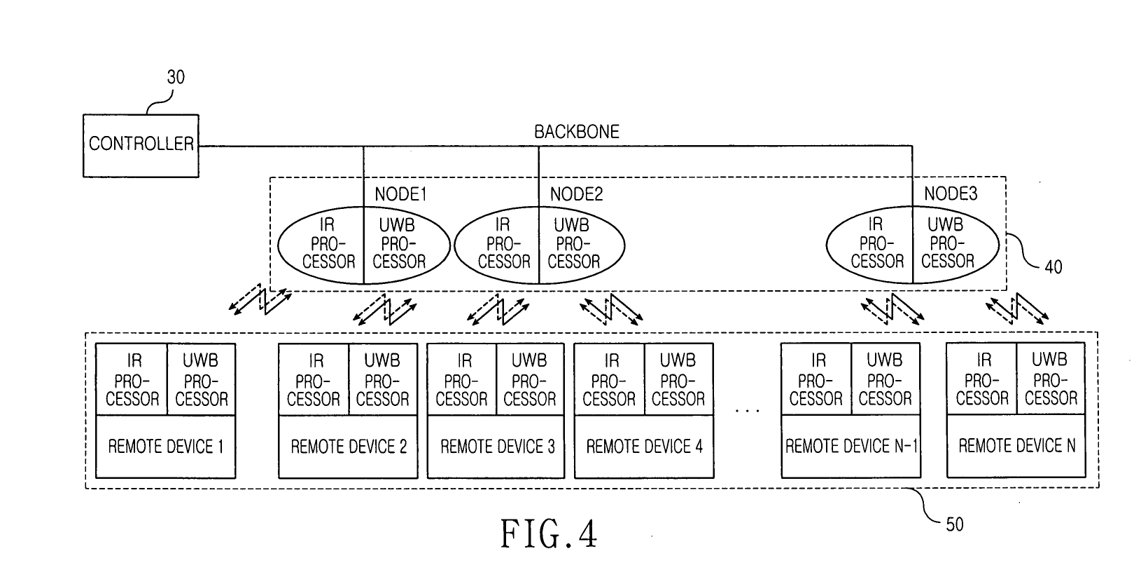

FIGS. 3 and 4 are conceptual views illustrating communication status among ultra-wideband terminals according to an embodiment of the present invention.

FIG. 3 shows, by way of non-limitative example, data communication between ultra-wideband terminals 10, 20 according to an embodiment of the present invention. Each of ultra-wideband terminals 10, 20 includes an IR process section 11 or 21 for transmitting a security key, and a UWB process section 12 or 22 for processing UWB signals. The UWB terminals transmit/receive a security key and encoded data using the IR process section 11 or 21 and the UWB process section 12 or 22.

FIG. 4 is a view illustrating an example in which an upper controller 30 performs data communication with a plurality of remote devices (remote device 1, remote device 2, remote device 3, . . . , remote device (N-1), and remote device N) 50 through a plurality of nodes (NODE 1, NODE 2, and NODE 3) 40 connected to the controller 30 through a backbone. Referring to FIG. 4, each of the nodes 40 and the remote devices comprises an IR process section and a UWB process section, in which the IR process section functions to transmit/receive a security key and the UWB process section functions to transmit/receive encoded data.

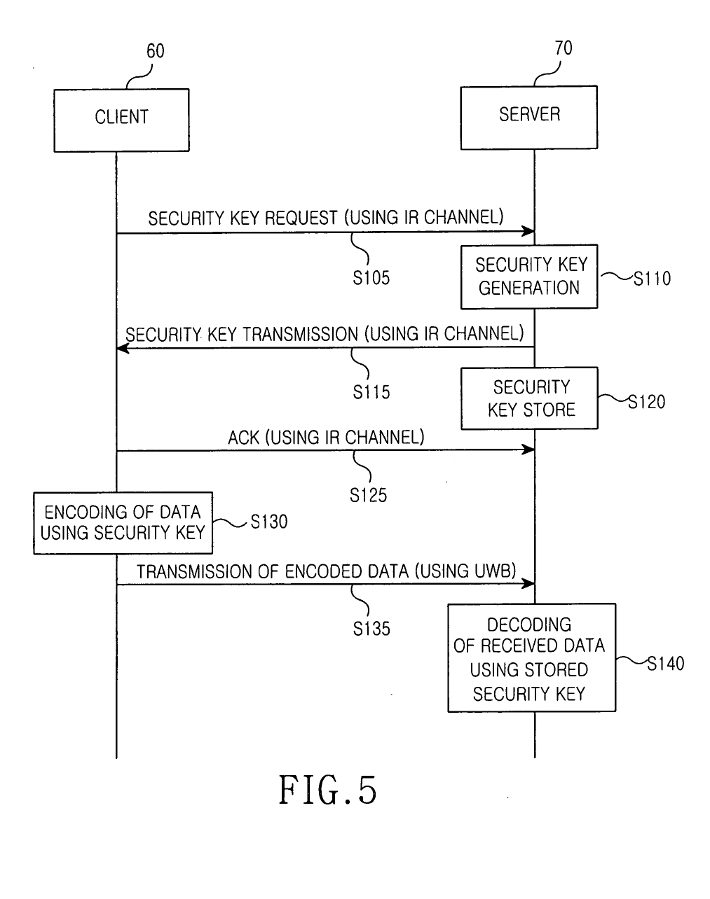

FIG. 5 depicts an example of a process of encoding/decoding an ultra-wideband signal according to an embodiment of the present invention. A client 60 represents a UWB terminal to transmit data, and a server 70 represents a UWB terminal to receive data. The client 60 requests the server 70 to transmit a security key S1 using an IR channel (step 105). The server 70 generates a security key in response to the request (step 110) and then transmits the generated security key to the client 60 using an IR channel (step 115). The IR channel between the client 60 and the server 70 is preferably set using the method defined by the Infrared Data Association (IrDA). The server 70 stores the generated security key (step 120).

After having received a security key from server 70, the client 60 transmits an acknowledgment signal (ACK) to acknowledge the reception of the security key to the server 70 (step 125). If the server 70 has not received the acknowledgment signal (ACK) within a predetermined time period after transmitting a security key to the client 60, the server 70 re-transmits the security key.

The client 60, having transmitted the acknowledgment signal (ACK) to the server 70, encodes data to transmit to the server 70 using the security key received from the server 70 (step 130). Subsequently, the client 60 transmits the encoded data to the server 70 using UWB (step 135).

After step 135, the server 70 restores data received through step 135 using the security key stored in step 120 (step 140).

Transmission of encoded data from the server 70 to the client 60 is preferably performed in the same way using respective equipment of the client and server identically configured.

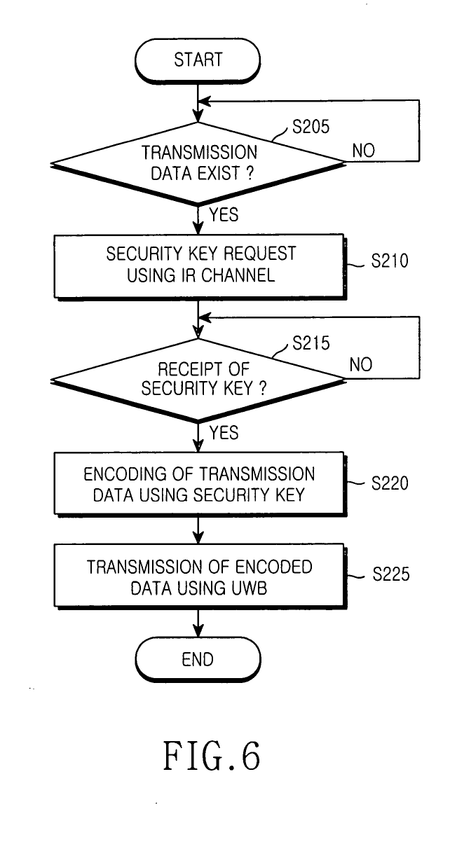

FIG. 6 is a flowchart for explaining an exemplary process of encoding and transmitting an ultra-wideband signal, and in particular a process of a UWB terminal corresponding to the client 60 of FIG. 5, according to an embodiment of the present invention. Referring again to FIG. 6, when a UWB terminal (hereinafter, referred to as “first UWB terminal”) is ready to transmit data to another UWB terminal (hereinafter, referred to as “second UWB terminal”), the first UWB terminal requests a security key from the second UWB terminal using an IR channel (steps 205 and 210). Upon having received a security key from the second UWB terminal, the first UWB terminal encodes transmission data using the security key (steps 215 and 220), and transmits the encoded data using UWB (step 225).

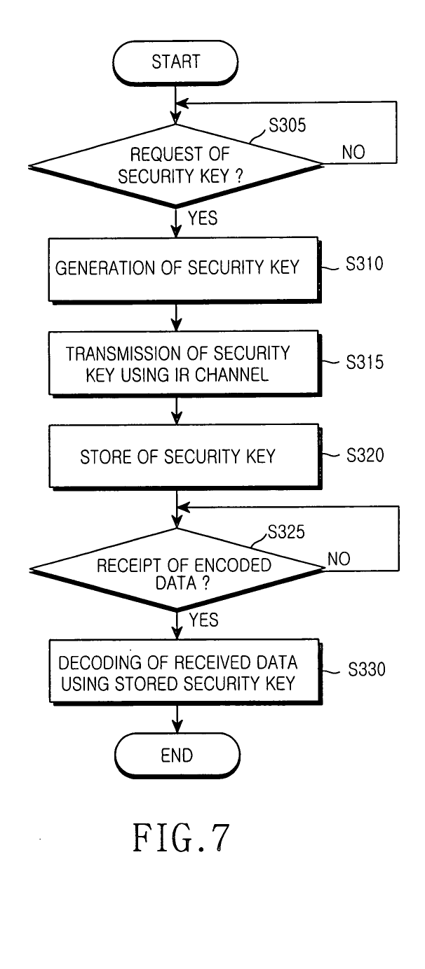

FIG. 7 is a flowchart for explaining an exemplary process of decoding a received ultra-wideband signal as performed by a UWB terminal of the server 70 of FIG. 5, according to an embodiment of the present invention. Referring again to FIG. 7, the second UWB terminal, having received the request of a security key from the first UWB terminal, generates a security key using a predetermined security key generation algorithm (steps 305 and 310). Subsequently, the second UWB terminal transmits the security key to the first UWB terminal using an IR channel and stores the security key in the second UWB terminal (steps 315 and 320). The order of steps 315 and 320 can be reversed. Since any known and suitable security key generation algorithm may be utilized, details of a particular algorithm will be omitted herein.

Finally, when the second UWB terminal, awaiting reception of encoded data transmitted from the first UWB terminal, receives the encoded data, the second UWB terminal restores original data from the received data using the security key stored in step 320 (step 330).

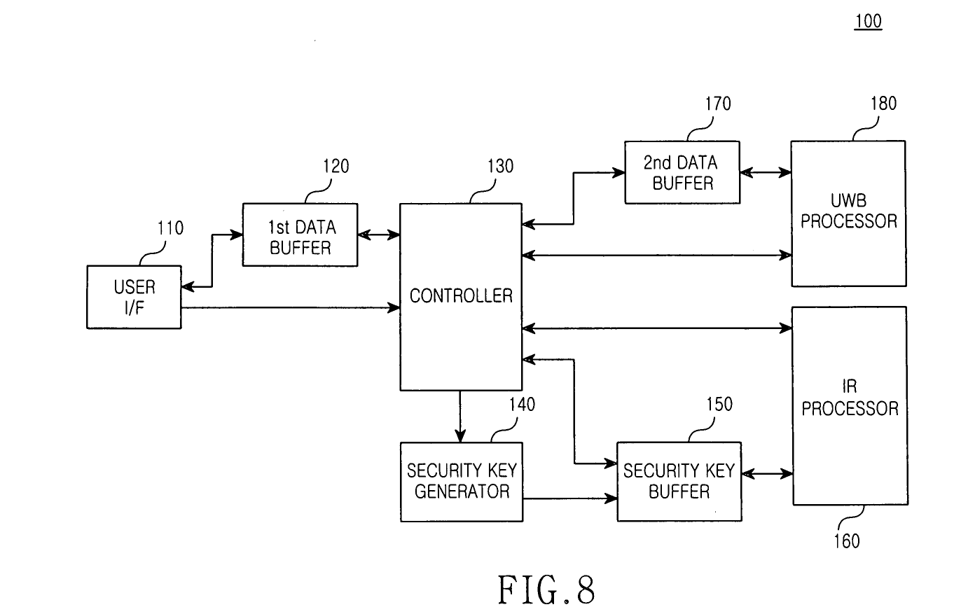

FIG. 8 is an exemplary functional block diagram of an ultra-wideband terminal 100 according to an embodiment of the present invention. The ultra-wideband terminal 100 includes a user interface section 110, a first data buffer 120, a control section 130, a security key generation section 140, a security key buffer 150, an IR process section 160, a second data buffer 170, and a UWB process section 180.

The user interface section 110 is an element for interfacing between a user and the UWB terminal 100.

The first data buffer 120 temporarily stores transmission data inputted through the user interface section 110 and reception data to output through the user interface section 110.

The security key generation section 140 generates a security key when receiving a security key generation command from the control section 130.

The security key buffer 150 stores a security key generated from the security key generation section 140 or a security key received from another UWB terminal through the IR process section 160.

The second data buffer 170 temporarily stores encoded data to be transmitted to another UWB terminal through the UWB process section 180.

The UWB process section 180 allows the UWB terminal 100 to perform data communication using UWB with another UWB terminal.

The IR process section 160 allows the UWB terminal 100 to perform data communication using an IR channel with another UWB terminal.

The control section 130 controls operations of the first data buffer 120, the security key generation section 140, the security key buffer 150, the IR process section 160, the second data buffer 170, and the UWB process section 180.

First, when receiving by means of the user interface 110 a signal informing that there is data to transmit to another UWB terminal, the control section 130 requests a security key from the corresponding UWB terminal through the IR process section 160. Next, when a security key generated by the corresponding UWB terminal is received through the IR process section 160, the control section 130 controls the IR process section 160 so that the security key is stored in the security key buffer 150. Subsequently, the control section 130 encodes transmission data stored in the first data buffer 120 using the security key stored in the security key buffer 150, stores the encoded data in the second data buffer 170, and controls the second data buffer 170 so that the encoded data are transmitted to the corresponding UWB terminal through the UWB process section 180.

Upon receiving a security key request signal through the IR process section 160, the control section 130 transmits a security key generation command to the security key generation section 140. Next, when the security key generation section 140 generates a security key and stores the generated security key in the security key buffer 150, the control section 130 reads the security key from the security key buffer 150 and controls the IR process section 160 so that the security key is transmitted to another UWB terminal through the IR process section 160. Subsequently, when the UWB process section 180 receives encoded data, the control section 130 controls the UWB process section 180 so that the encoded data are stored in the second data buffer 170, reads the security key from the security key buffer 150, and restores original data from encoded data stored in the second data buffer 170 using the read security key. Next, the control section 130 controls the first data buffer 120 and the user interface 110 so that the restored data are provided to a corresponding user through the first data buffer 120 and the user interface 110.

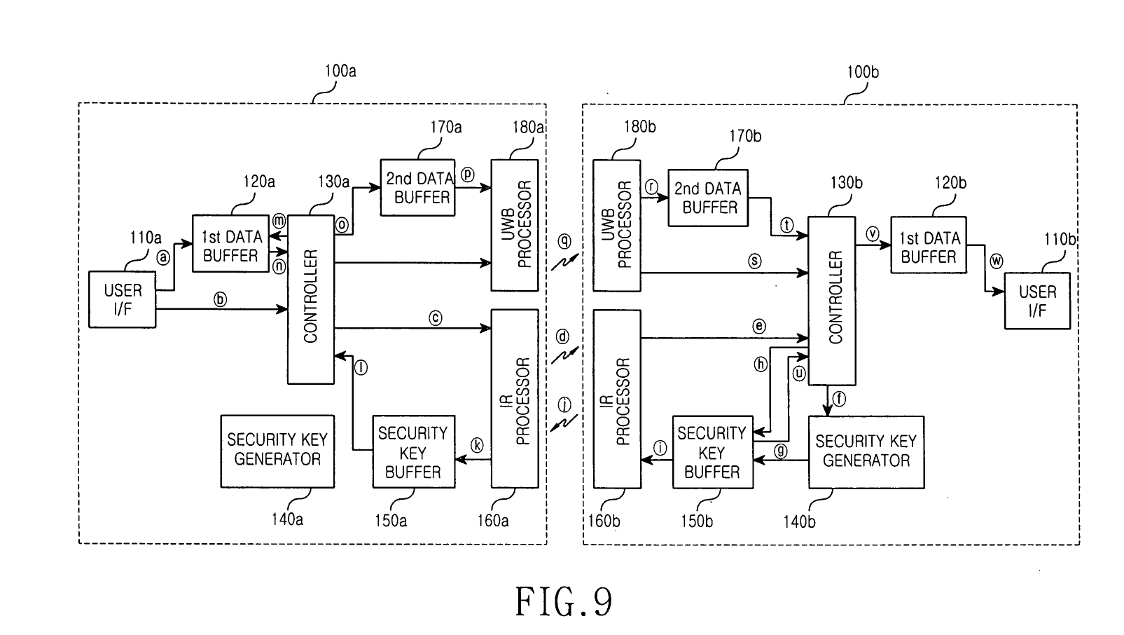

FIG. 9 is a block diagram that describes, in the context of two ultra-wideband terminals such as the terminal 100 in FIG. 8, the encoding, transmitting, receiving and decoding of an ultra-wideband signal according to an embodiment of the present invention. Specifically, FIG. 9 illustrates a process in which a second UWB terminal 100b generates a security key and transmits the generated security key to a first UWB terminal 100a so that the first UWB terminal 100a can encode and transmits data to the second UWB terminal 100b.

As shown in FIG. 9, when a user interface section 110a in a first UWB terminal 100a stores transmission data in a first data buffer 120a (\mathring{a}) and notifies a control section 130a that there is data to be transmitted (\mathring{b}), the control section 130a requests a security key from a second UWB terminal 100b through an IR process section 160a (\mathring{c} and \mathring{d}). Upon receiving a security key request signal, the IR process section 160b in the second UWB terminal 100b transmits the request signal to a control section 130b (e).

The control section 130b, having received the security key request signal, transmits a security key generation command to a security key generation section 140b (\mathring{f}), and then the security key generation section 140b generates a security key in response to the security key generation command and stores the generated security key in a security key buffer 150b (\mathring{g}). Next, the control section 130b controls the security key buffer 150b to transmit the security key to the first UWB terminal 100a through the IR process section 160b (\mathring{h}). Then, according to a control signal received from the control section 130b, the security key buffer 150b transmits the security key to the first UWB terminal 100a through the IR process section 160b (\mathring{i} and \mathring{j}).

The IR process section 160a of the first UWB terminal 100a, having received the security key, stores the security key in a security key buffer 150a (\mathring{k}). Then, the control section 130a reads the security key from the security key buffer 150a (\mathring{l}), receives transmission data from the first data buffer 120a (\mathring{m} and \mathring{n}), encodes the transmission data using the security key, and stores the encoded data in a second data buffer 170a (\mathring{o}).

The control section 130a also controls a UWB process section 180a so that the encoded data stored in the second data buffer 170a are transmitted to the second UWB terminal 100b using UWB (\mathring{p} and \mathring{q}).

A UWB process section 180b of the second UWB terminal 100b receives UWB data transmitted from the first UWB terminal 100a, and stores the received data in a second data buffer 170b (\mathring{r}). Subsequently, the control section 130b receives a notification signal, which is a signal notifying data reception, from the UWB process section 180b (\mathring{s}), and then reads the encoded data stored in the second data buffer 170a and the security key stored in the security key buffer 150b (\mathring{t} and \mathring{u}). Next, the control section 130b restores original data from the encoded data using the security key, and provides the restored original data to a user by means of the first data buffer 120b and the user interface section 110b (\mathring{v} and \mathring{w}).

According to the present invention described above, data encoded using a security key are carried by UWB signals and the security key is transmitted through an IR channel, thereby overcoming the serious security vulnerability of wireless data transmission in the prior art. The inventive techniques and apparatus which combine UWB and IR technology are particularly advantageous in affording secure transmission for relatively large amounts of data.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting an encoded ultra-wideband signal, the method comprising:
a first step in which an ultra-wideband terminal of a transmission part uses an infrared channel to request, of an ultra-wideband terminal of a reception part, a security key;
a second step in which the ultra-wideband terminal of the transmission part receives, in response to the request, a security key transmitted from the ultra-wideband terminal of the reception part;
a third step in which the ultra-wideband terminal of the transmission part encodes transmission data using the received security key; and
a fourth step in which the ultra-wideband terminal of the transmission part uses ultra-wideband to transmit the encoded transmission data to the ultra-wideband terminal of the reception part.

2. The method of claim 1, further comprising a step in which the ultra-wideband terminal of the transmission part, having received the security key, transmits an acknowledgment signal (ACK) to the ultra-wideband terminal of the reception part.

3. The method of claim 2, wherein one of the ultra-wideband terminals of the transmission part and of the reception part is configured to perform as a client and the other of the terminals is configured to perform as a server to the client.

4. The method of claim 1, wherein one of the ultra-wideband terminals of the transmission part and of the reception part is configured to perform as a client and the other of the terminals is configured to perform as a server to the client.

5. A method for receiving an encoded ultra-wideband signal, the method comprising:
a first step of generating a security key in response to reception of a security key request signal from an ultra-wideband terminal of a transmission part;
a second step of transmitting the security key to the ultra-wideband terminal of the transmission part using an infrared radiation channel and of storing the security key;
a third step of receiving encoded data transmitted from the ultra-wideband terminal of the transmission part through ultra wideband (UWB); and
a fourth step of restoring original data from the data received through the third step using the security key stored through the second step.

6. The method of claim 5, wherein the second step further comprises a sub-step of re-transmitting the security key if an acknowledgment signal (ACK) transmitted from the ultra-wideband terminal of the transmission part is not received within a predetermined time period after the security key is transmitted.

7. The method of claim 6, wherein the infrared radiation channel is configured as specified by the Infrared Data Association (IrDA).

8. The method of claim 5, wherein the infrared radiation channel is configured as specified by the Infrared Data Association (IrDA).

9. An ultra-wideband terminal comprising:
a control section for controlling the ultra-wideband terminal to use an ultra wideband to transmit/receive data encoded by a predetermined security key and to use an infrared radiation channel to transmit/receive the security key;
an ultra-wideband process section for using ultra wideband to perform data communication with another ultra-wideband terminal;
an infrared radiation process section for performing data communication using said infrared radiation channel with said another ultra-wideband terminal;
a first data buffer for storing either transmission data to be transmitted to said another ultra-wideband terminal that have not yet been encoded, or data restored after being received from said another ultra-wideband terminal; and
a security key generation section for generating a security key in response to a security key generation command of the control section.

10. The ultra-wideband terminal of claim 9, further comprising: a security key buffer for storing the security key generated from the security key generation section and for storing a security key received from said another ultra-wideband terminal through the infrared radiation process section.

11. The ultra-wideband terminal of claim 10, further comprising a second data buffer for storing encoded data to be transmitted to said another ultra-wideband terminal through the ultra-wideband process section and for storing data received from another ultra-wideband terminal that have not yet been restored.

12. The ultra-wideband terminal of claim 11, wherein:
when there is data to be transmitted to said another ultra-wideband terminal in the first data buffer, the control section requests a security key to said another ultra-wideband terminal through the infrared radiation process section; and
when a security key is received from said another ultra-wideband terminal through the infrared radiation process section, the control section stores the received security key in the security key buffer.

13. The ultra-wideband terminal of claim 12, wherein the control section encodes transmission data stored in the first data buffer using said received security key, stores the encoded transmission data in the second data buffer, and controls the second data buffer so that the encoded transmission data are transmitted to said another ultra-wideband terminal through the ultra-wideband process section.

14. The ultra-wideband terminal of claim 13, wherein:
the ultra-wideband process section and the infrared radiation process section are each configured for using ultra-wideband to perform data communication with a plurality of ultra-wideband terminals;
the security key buffer is configured for storing a security key received from any of the plural ultra-wideband terminals; and
the second data buffer is configured for storing encoded data to be transmitted to any of the plural ultra-wideband terminals through the ultra-wideband process section and for storing data not yet restored which has been received from any of the plural ultra-wideband terminals.

15. The ultra-wideband terminal of claim 12, wherein:
the ultra-wideband process section and the infrared radiation process section are each configured for using ultra-wideband to perform data communication with a plurality of ultra-wideband terminals;
the security key buffer is configured for storing a security key received from any of the plural ultra-wideband terminals; and
the second data buffer is configured for storing encoded data to be transmitted to any of the plural ultra-wideband terminals through the ultra-wideband process section and for storing data not yet restored which has been received from any of the plural ultra-wideband terminals.

16. The ultra-wideband terminal of in claim 11, wherein:
the ultra-wideband process section and the infrared radiation process section are each configured for using ultra-wideband to perform data communication with a plurality of ultra-wideband terminals;
the security key buffer is configured for storing a security key received from any of the plural ultra-wideband terminals; and
the second data buffer is configured for storing encoded data to be transmitted to any of the plural ultra-wideband terminals through the ultra-wideband process section and for storing data not yet restored which has been received from any of the plural ultra-wideband terminals.

17. The ultra-wideband terminal of claim 10, wherein:
the ultra-wideband process section and the infrared radiation process section are each configured for u sing ultra-wideband to perform data communication with a plurality of ultra-wideband terminals; and
the security key buffer is configured for storing a security key received from any of the plural ultra-wideband terminals.

18. The ultra-wideband terminal of claim 9, wherein the ultra-wideband process section and the infrared radiation process section are each configured for using ultra-wideband to perform data communication with a plurality of ultra-wideband terminals.

19. The ultra-wideband terminal of claim 9, wherein:
the control section transmits a security key generation command to the security key generation section in response to a security key request signal received through the infrared radiation process section; and
the control section, upon said storing the security key generated, reads from the security key buffer said security key generated and performs a control operation so that said security key generated is transmitted to said another ultra-wideband terminal through the infrared radiation process section.

20. The ultra-wideband terminal of claim 19, wherein,
when having received encoded data through the ultra-wideband process section, the control section stores the encoded data in the second data buffer and restores original data from the data stored in the second data buffer using a security key stored in the security key buffer.
